(19) United States
(12) Patent Application Publication
(10) Pub. No.: US 2022/0413978 A1
(43) Pub. Date: Dec. 29, 2022

(54) METHODS AND APPARATUSES FOR AUTOMATIC OPERATIONAL MAINTENANCE

(71) Applicant: SENSETIME INTERNATIONAL PTE. LTD., Singapore (SG)

(72) Inventors: Jiacheng Wu, Singapore (SG); Shuai Zhang, Singapore (SG); Jinliang Lin, Singapore (SG); Gan Xiao, Singapore (SG)

(21) Appl. No.: 17/364,425

(22) Filed: Jun. 30, 2021

Related U.S. Application Data
(63) Continuation of application No. PCT/IB2021/055786, filed on Jun. 29, 2021.

(30) Foreign Application Priority Data
Jun. 28, 2021 (SG) 10202107096Q

(51) Int. Cl. G06F 11/30; G06F 11/32; G06F 11/07; G06F 11/14

(52) U.S. Cl. CPC G06F 11/3006; G06F 11/3075; G06F 11/327; G06F 11/0772; G06F 11/1441

(57) ABSTRACT

An embodiment of the present disclosure provides a method and an apparatus for automatic operational maintenance. The method is executed on a cloud, and includes: in response to determining that an operational maintenance task in a preset task list satisfies an execution condition, issuing an operational maintenance instruction corresponding to the operational maintenance task to a remote device; receiving an execution result in response to the operational maintenance instruction returned by the remote device.

### CROSS REFERENCE TO RELATED APPLICATION

This application is a continuation application of International Application No. PCT/IB2021/055786 filed on Jun. 29, 2021, which claims priority to Singapore Patent Application No. 10202107096Q, filed on Jun. 28, 2021, entitled “METHODS AND APPARATUSES FOR AUTOMATIC OPERATIONAL MAINTENANCE”, the disclosure of which is incorporated herein by reference in its entirety for all purposes.

### TECHNICAL FIELD

The present disclosure relates to the field of computer communication technologies, and in particular to a method and an apparatus of automatic operational maintenance.

### BACKGROUND

In a centralized system involving large-scale devices, to enable the devices to provide stable and long-term services in several scenarios, continuous operational maintenance is required for the devices. In related art, the operational maintenance is performed in a way that operation and maintenance personnel conduct operational maintenance for individual devices by coming to the device site periodically. For an operational maintenance task with a specific time requirement, a large amount of labor is generally needed to perform operation for several devices.

### SUMMARY

In view of this, an embodiment of the present disclosure provides a method and an apparatus for automatic operational maintenance.

Specifically, one or more embodiments of the present disclosure are implemented by the following technical solution.

According to a first aspect, provided is a method of automatic operational maintenance, the method being executed on a cloud and including: in response to determining that an operational maintenance task in a preset task list satisfies an execution condition, issuing an operational maintenance instruction corresponding to the operational maintenance task to a remote device; receiving an execution result in response to the operational maintenance instruction returned by the remote device.

In some optional embodiments, the operational maintenance task includes: a task content, a remote device identifier, and a task execution time; determining that an operational maintenance task in the preset task list satisfies an execution condition includes: determining that a current time meets the task execution time of an operational maintenance task in the preset task list; issuing an operational maintenance instruction corresponding to the operational maintenance task to a remote device includes: issuing the operational maintenance instruction corresponding to the task content in the operational maintenance task to a remote device corresponding to the remote device identifier in the operational maintenance task.

In some optional embodiments, the operational maintenance task includes a plurality of remote device identifiers; issuing the operational maintenance instruction corresponding to the task content in the operational maintenance task to the remote device corresponding to the remote device identifier in the operational maintenance task includes: issuing the operational maintenance instruction corresponding to the task content in the operational maintenance task to a plurality of remote devices corresponding to a plurality of remote device identifiers in the operational maintenance task respectively.

In some optional embodiments, issuing the operational maintenance instruction corresponding to the task content in the operational maintenance task to the remote devices respectively corresponding to a plurality of remote device identifiers in the operational maintenance task includes: for each of the remote devices respectively corresponding to the plurality of remote device identifiers in the operational maintenance task, establishing a thread for the remote device; and issuing the operational maintenance instruction corresponding to the task content in the operational maintenance task to the plurality of remote devices in parallel through a plurality of the threads.

In some optional embodiments, the operational maintenance instruction includes at least one of: remote device upgrading, application installation, running state switching, restart and shutdown.

In some optional embodiments, after receiving the execution result of the operational maintenance instruction returned by the remote device, the method further includes: updating a state of the operational maintenance task based on the execution result.

In some optional embodiments, after updating the state of the operational maintenance task based on the execution result, the method further includes: in response to that the state of the operational maintenance task is failed, marking a failed reason in the execution result for the operational maintenance task, wherein the failed reason is used for being viewed by operational maintenance personnel.

In some optional embodiments, after updating the state of the operational maintenance task based on the execution result, the method further includes: generating promotion information based on the updated state of the operational maintenance task, wherein the promotion information is used to notify the operational maintenance personnel of the execution result of the operational maintenance task.

According to a second aspect, provided is a method of automatic operational maintenance, the method being executed on a remote device and including: receiving an operational maintenance instruction from a cloud, wherein the operational maintenance instruction is an operational maintenance instruction corresponding to an operational maintenance task issued by the cloud in response to determining that the operational maintenance task in a preset task list satisfies an execution condition; executing an operational maintenance operation in response to the operational maintenance instruction and returning an execution result to the cloud.

According to a third aspect, provided is an apparatus for automatic operational maintenance, the apparatus being deployed on a cloud and including: an instruction issuing module, configured to, in response to determining that an operational maintenance task in a preset task list satisfies an execution condition is present, issue an operational maintenance instruction in response to the operational maintenance task to a remote device; a result receiving module, configured to receive an execution result of the operational maintenance instruction returned by the remote device.

In some optional embodiments, the operational maintenance task includes a task content, a remote device identifier, and a task execution time; the instruction issuing module is specifically configured to: when a current time meets a task execution time of the operational maintenance task in the preset task list, issue the operational maintenance instruction corresponding to the task content in the operational maintenance task to the remote device corresponding to the remote device identifier in the operational maintenance task.

In some optional embodiments, the operational maintenance task includes a plurality of remote device identifiers; the instruction issuing module is configured to issue the operational maintenance instruction corresponding to the task content in the operational maintenance task to the remote device corresponding to the remote device identifier in the operational maintenance task, including: issuing the operational maintenance instruction corresponding to the task content in the operational maintenance task to a plurality of remote devices corresponding to a plurality of remote device identifiers in the operational maintenance task respectively.

In some optional embodiments, the instruction issuing module is configured to issue the operational maintenance instruction corresponding to the task content in the operational maintenance task to the remote devices respectively corresponding to a plurality of remote device identifiers in the operational maintenance task, including: for each of the remote devices respectively corresponding to the plurality of remote device identifiers in the operational maintenance task, establishing a thread for the remote device; and issuing the operational maintenance instruction corresponding to the task content in the operational maintenance task to the plurality of remote devices in parallel through a plurality of the threads.

In some optional embodiments, the operational maintenance instruction includes at least one of: remote device upgrading, application installation, running state switching, restart and shutdown.

In some optional embodiments, after receiving the execution result of the operational maintenance instruction returned by the remote device, the result receiving module is further configured to: update a state of the operational maintenance task based on the execution result.

In some optional embodiments, after updating the state of the operational maintenance task based on the execution result, the result receiving module is further configured to: in response to that the state of the operational maintenance task is failed, mark a failed reason in the execution result for the operational maintenance task, wherein the failed reason is used for being viewed by operational maintenance personnel.

In some optional embodiments, after updating the state of the operational maintenance task based on the execution result, the result receiving module is further configured to: generate promotion information based on the updated state of the operational maintenance task, wherein the promotion information is used to notify the operational maintenance personnel of the execution result for the operational maintenance task.

According to a fourth aspect, provided is an apparatus for automatic operational maintenance, the apparatus being deployed on a remote device and including: an instruction receiving module, configured to receive an operational maintenance instruction from a cloud, wherein the operational maintenance instruction is an operational maintenance instruction corresponding to an operational maintenance task issued by the cloud in response to determining that the operational maintenance task in a preset task list satisfies an execution condition; an instruction executing module, configured to execute an operational maintenance operation in response to the operational maintenance instruction and return an execution result to the cloud.

According to a fifth aspect, provided is a computer program product, including computer programs/instructions, wherein the computer programs/instructions are executed by a processor to implement the method according to any one embodiment of the present disclosure.

According to a sixth aspect, provided is an electronic device, including a memory and a processor, wherein the memory is configured to store computer instructions run on the processor, and the processor is configured to, when executing the computer instructions, implement the method according to any one embodiment of the present disclosure.

According to a seventh aspect, provided is a computer readable storage medium, storing computer programs thereon, wherein the computer programs are executed by a processor to implement the method according to any one embodiment of the present disclosure.

In the technical solution of the embodiments of the present disclosure, an operational maintenance instruction corresponding to an operational maintenance task is issued by a cloud, such that a remote device may execute the corresponding operational maintenance task in response to a receipt of the operational maintenance instruction and return an execution result. In this way, operational maintenance personnel can perform maintenance operations to a device and learn a maintenance result without coming to device site and performing manual operation to the device. An operational maintenance task and execution condition for the operational maintenance task may be set in advance on the cloud and the operational maintenance task may be issued to the remote device when the operational maintenance task satisfies the execution condition, such that labor costs and time consumption may be greatly reduced. Further, compared with the maintenance operations involving labor force, the maintenance operation performed according to embodiments of the present disclosure is smarter, thus reducing the fault rate of the manual operations.

The above general descriptions and subsequent detailed descriptions are merely illustrative and explanatory and shall not be intended to limit the present disclosure.

### BRIEF DESCRIPTION OF THE DRAWINGS

To describe the technical solutions in one or more embodiments of the present disclosure or in the prior art more clearly, drawings required in descriptions of the embodiments of the present disclosure or the prior art will be briefly introduced below. It is apparent that the drawings described below are merely some embodiments of one or more embodiments of the present disclosure and other drawings may be obtained by those of ordinary skill in the prior art based on these drawings without paying creative work.

FIG. 1 is a flowchart of a method of automatic operational maintenance according to an embodiment of the present disclosure.

FIG. 2 is a flowchart of another method of automatic operational maintenance according to an embodiment of the present disclosure.

FIG. 3 is a flowchart of another method of automatic operational maintenance according to an embodiment of the present disclosure.

FIG. 3A is a schematic diagram of interaction of a cloud and a remote device according to an embodiment of the present disclosure.

FIG. 4 is a flowchart of a method of automatic operational maintenance according to an embodiment of the present disclosure.

FIG. 5 is a block diagram of an apparatus for automatic operational maintenance according to an embodiment of the present disclosure.

FIG. 6 is a block diagram of another apparatus for automatic operational maintenance according to an embodiment of the present disclosure.

FIG. 7 is a schematic diagram of hardware structure of an electronic device according to an embodiment of the present disclosure.

### DETAILED DESCRIPTION OF THE EMBODIMENTS

Exemplary embodiments will be described in detail herein, with the illustrations thereof represented in the drawings. When the following descriptions involve the drawings, like numerals in different drawings refer to like or similar elements unless otherwise indicated. The embodiments described in the following embodiments do not represent all embodiments consistent with the present disclosure. Rather, they are merely examples of apparatuses and methods consistent with some aspects of the present disclosure as detailed in the appended claims.

The terms used in the present disclosure are for the purpose of describing particular embodiments only, and are not intended to limit the present disclosure. Terms “a”, “the” and “said” in their singular forms used in the present disclosure and the appended claims are also intended to include plurality, unless clearly indicated otherwise in the context. It should also be understood that the term “and/or” as used herein refers to and includes any and all possible combinations of one or more of the associated listed items.

It is to be understood that, although the terms “first,” “second,” “third,” and the like may be used in the present disclosure to describe various information, such information should not be limited to these terms. These terms are only used to distinguish one category of information from another. For example, without departing from the scope of the present disclosure, first information may be referred as second information; and similarly, the second information may also be referred as the first information. Depending on the context, the term “if” as used herein may be interpreted as “when” or “upon” or “in response to determining”.

An embodiment of the present disclosure provides a method of automatic operational maintenance different from an operation by operational maintenance personnel on a device site, by which device maintenance can be performed by setting an operational maintenance task through a cloud.

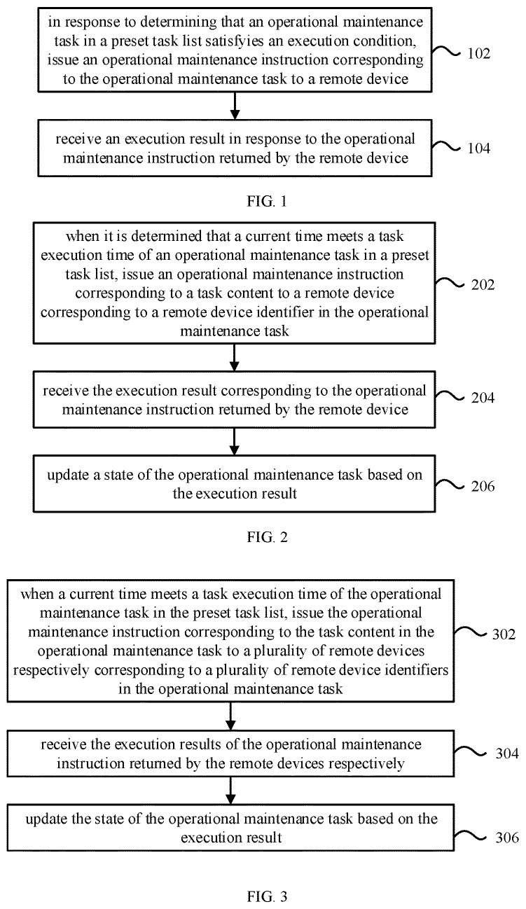

FIG. 1 is a flowchart of a method of automatic operational maintenance according to an embodiment of the present disclosure. The method may be applied in a cloud and include the following steps.

At step 102, in response to determining that an operational maintenance task in a preset task list satisfies an execution condition, an operational maintenance instruction corresponding to the operational maintenance task is issued to a remote device.

When a remote device needs to be maintained, an operational maintenance task may be preset in a task list of a cloud. The task list may include a plurality of operational maintenance tasks, and the operational maintenance task may be a maintenance operation for a remote device, for example, upgrading, state switching and restart and the like of the remote device, which can be manually defined by operational maintenance personnel. The operational maintenance task may be set for one remote device or for a plurality of remote devices.

Different operational maintenance tasks may have different execution conditions. For example, when the task list includes three operational maintenance tasks, i.e. task 1, task 2 and task 3, the task 1 may be executed when a timing is reached, the task 2 may be executed after the task 1 is completed, and the task 3 may be executed if the task 2 is failed.

In this step, when one or more operational maintenance tasks in the task list are detected to be satisfying the corresponding execution conditions, an operational maintenance instruction corresponding to the operational maintenance task may be issued to the remote device. The operational maintenance instruction is used to instruct the remote device to perform corresponding operational maintenance operation. The operational maintenance instruction includes at least one of: remote device upgrading, application installation, running state switching, restart and shutdown. For example, when the operational maintenance task is to shut down a device A at 0 o'clock, an operational maintenance instruction for shutdown is issued to the device A at 0 o'clock; when the operational maintenance task is to switch a device B and a device C to standby state after three hours, an operational maintenance instruction for switching to standby state is issued to the devices B and C after three hours.

Specifically, an agency service may be installed on the remote device in advance. The agency service includes an interface for the cloud to perform remote calling, for example, a Transmission Control Protocol (TCP) interface of Remote Procedure Call (RPC). The cloud may issue an operational maintenance instruction through the interface. The operational maintenance instruction corresponding to the operational maintenance task may also be issued in another manner, for example, commanded by another remote tool, which is not limited herein.

At step 104, an execution result in response to the operational maintenance instruction returned by the remote device is received.

The remote device may return the execution result to the cloud after executing an operation instructed by the operational maintenance instruction.

Specifically, the remote device may return the execution result by sending a packet to the cloud through a specified transmission channel, or return the execution result through the above remotely-called interface. The execution result may include whether an operational maintenance instruction is completed, an execution time, an execution duration, and a failed reason for unsuccessful execution, and the like. The operational maintenance personnel may view the execution result on the cloud to know about an operational maintenance state of the remote device.

In the method of automatic operational maintenance provided in the embodiments of the present disclosure, an operational maintenance instruction corresponding to an operational maintenance task is issued through a cloud, such that a remote device may execute the corresponding operational maintenance task after receiving the operational maintenance instruction and return an execution result. In this way, operational maintenance personnel can perform automatic maintenance to a device and learn a maintenance result without performing manual operation to the device on a site. The operational maintenance task may be set in advance on the cloud and issued to the remote device when the operational maintenance task satisfies an execution condition, such that operational maintenance personnel can perform maintenance operations without having to wait until the maintenance precondition is satisfied. Therefore, labor costs and time consumption are greatly reduced. Further, compared with the conventional operation involving labor force, the operation of the present disclosure is smarter, thus reducing the fault rate of the manual operations.

FIG. 2 is a flowchart of a method of automatic operational maintenance according to an embodiment of the present disclosure. The method may be applied in a cloud and include the following steps, where steps same as in step 1 are not described any longer.

At step 202, when it is determined that a current time meets a task execution time of an operational maintenance task in a preset task list, an operational maintenance instruction corresponding to a task content is issued to a remote device corresponding to a remote device identifier in the operational maintenance task.

In this embodiment, the operational maintenance task may include but not limited to: a task content, a remote device identifier, and a task execution time. The task content is an operational maintenance operation to be performed for the remote device; the remote device identifier may be a name or an address or the like of the remote device for representing a specific remote device, where there may be one or more remote device identifiers; the task execution time is a task execution condition, which may be a specific timing or a particular period of time, for example, after one hour.

In this step, whether an operational maintenance task in the task list satisfies a corresponding task execution time condition may be detected in real time. Particularly, whether an operational maintenance task in the task list satisfies the corresponding task execution time condition may be detected cyclically. When it is detected that an operational maintenance task does not satisfy the corresponding task execution time condition, the operational maintenance task unsatisfying the corresponding task execution time condition is moved to the end of the task list to accelerate the detecting speed, such that the operational maintenance tasks satisfying corresponding conditions can be performed in time.

When the current time meets the task execution time of an operational maintenance task in the preset task list, an operational maintenance instruction corresponding to the task content is issued to the remote device corresponding to the remote device identifier in the operational maintenance task. The operational maintenance instruction corresponds to the task content and includes at least one of: remote device upgrading, application installation, running state switching, restart and shutdown.

For example, in the operational maintenance task, the task execution time is 6 PM, the remote device identifier is device A and the task content is shutdown. In this case, an operational maintenance instruction for shutdown is issued to the device A at 6 PM, and the device A shuts down and returns an execution result after receiving the operational maintenance instruction. For another example, in the operational maintenance task, the task execution time is after five hours, the remote device identifier is device B and device C, and the task content is upgrading to a particular version and restarting. In this case, an operational maintenance instruction for upgrading to a particular version and restarting is issued to the devices B and C at the same time after five hours, and the devices B and C obtain an upgrade package corresponding to the version after receiving the operational maintenance instruction and then perform upgrading and restart and then return an execution result.

At step 204, the execution result corresponding to the operational maintenance instruction returned by the remote device is received.

At step 206, a state of the operational maintenance task is updated based on the execution result.

The execution result may include whether an operational maintenance instruction is completed, an actual execution time, an actual execution duration, and a failed reason for unsuccessful execution, and the like.

The state of the operational maintenance task may be un-executed, succeed or failed. The state of the operational maintenance task may be updated from un-executed to succeed or failed according to the execution result returned by the remote device.

In an example, in response to that the state of the operational maintenance task is a failed, a failed reason in the execution result is marked for the operational maintenance task, where the failed reason is to be viewed by an operational maintenance personnel. Further, an execution duration and an actual execution time in the execution result may be recorded.

In an example, promotion information may be generated according to the updated state of the operational maintenance task. The promotion information is to notify the operational maintenance personnel of the execution result for the operational maintenance task. The promotion information may be promotion information of text form generated on a display of the cloud, or may be playable promotion information of audio form generated. The content of the promotion information may be the execution result returned by the remote device, such that the operational maintenance personnel can know about the execution situation of the operational maintenance task.

In the method of automatic operational maintenance provided in the embodiments of the present disclosure, an operational maintenance instruction corresponding to an operational maintenance task is issued through a cloud, such that a remote device may execute the corresponding operational maintenance task after receiving the operational maintenance instruction and return an execution result. In this way, operational maintenance personnel can perform automatic maintenance to a device and learn a maintenance result without performing manual operation to the device on a site. An execution time of the operational maintenance task may be set in advance on the cloud and issued to the remote device when the operational maintenance task satisfies the execution time, such that operational maintenance personnel can perform maintenance operations without having to wait until the execution time is reached. Therefore, labor costs and time consumption are greatly reduced. Further, compared with the conventional operation involving labor force, the operation of the present disclosure is smarter, thus reducing the fault rate of the manual operations.

FIG. 3 is a flowchart of a method of automatic operational maintenance according to an embodiment of the present disclosure. The method may be applied in a cloud. In this method, there may be a plurality of remote devices. The method includes the following steps where the steps same as in the flow of FIG. 2 will not be described any longer.

At step 302, when a current time meets a task execution time of the operational maintenance task in the preset task list, the operational maintenance instruction corresponding to the task content in the operational maintenance task is issued to a plurality of remote devices respectively corresponding to a plurality of remote device identifiers in the operational maintenance task.

In this embodiment, the operational maintenance task includes a plurality of remote device identifiers, and each remote device identifier corresponds to one remote device. When the current time meets the task execution time of an operational maintenance task in the preset task list, a same operational maintenance instruction is issued to a plurality of remote devices corresponding to the operational maintenance task.

In an example, the cloud may establish one thread for issuing the same operational maintenance instruction to the remote devices respectively corresponding to the plurality of remote device identifiers in sequence. For example, the plurality of remote device identifiers in the operational maintenance task are device A, device B, device C and device D. When the current time meets the task execution time, one thread for issuing an operational maintenance instruction is established, through which the operational maintenance instruction is issued firstly to the device A, and then to device B, and then to device C and then to device D.

In another example, the cloud may establish one thread for a respective remote device corresponding to each of the plurality of remote device identifiers in the operational maintenance task, such that the operational maintenance instruction corresponding to the task content in the operational maintenance task can be issued to a plurality of remote devices at the same time in parallel through a plurality of threads. For example, as shown in FIG. 3A, a plurality of remote device identifiers in the operational maintenance task are device A, device B, and device C. When it is determined that the current time meets the task execution time of a particular operational maintenance task in the task list, an executor on the cloud may establish three threads for issuing the operational maintenance instruction, i.e. thread 1, thread 2 and thread 3, which are used to send the same operational maintenance instruction to the devices A, B and C respectively. The devices A, B and C receive the operational maintenance instruction through agency service, and then perform corresponding operational maintenance task, and then return the execution result to the corresponding thread after completing the execution, and also update the state of the operational maintenance task in the task list.

In this example, the distributions of the operational maintenance instructions for the remote devices are processed in parallel without mutual interference. In this case, repetitive human labor is greatly reduced, and the operational maintenance instruction can be issued to a large number of remote devices more efficiently. Thus, the remote devices can be synchronized in state more quickly such that a plurality of remote devices can achieve consistent state in an extremely tiny time.

At step 304, the execution results of the operational maintenance instruction returned by the remote devices are received respectively.

At step 306, the state of the operational maintenance task is updated based on the execution result.

The state of the operational maintenance task may be updated based on the execution result of each remote device. The state of the operational maintenance task may be un-executed, succeed and failed. Specifically, the state may include a success or a failed of all the operational maintenance instructions of a plurality of remote devices and a success or failed of the operational maintenance instruction of each remote device. In a case that the execution result is failed, a failed reason may be marked for being viewed by operational maintenance personnel.

In the method of automatic operational maintenance provided in the embodiments of the present disclosure, an operational maintenance instruction corresponding to an operational maintenance task is issued to a plurality of remote devices at the same time through a cloud, such that the plurality of remote devices may perform a corresponding operational maintenance task after receiving the operational maintenance instruction, and return an execution result. In this way, the operational maintenance personnel do not need to perform manual operation to the device in sequence on the device site, and a plurality of remote devices can perform automatic maintenance and achieve consistent state with an extremely tiny time difference, which reduces the repetitive human labor. An execution time of the operational maintenance task of a plurality of remote devices may be set in advance on a cloud. When the operational maintenance task satisfies the corresponding task execution time condition, an operational maintenance instruction is issued to the remote devices, such that the operational maintenance personnel can perform maintenance operations without having to wait until the maintenance time is reached. Therefore, labor costs and time consumption are greatly reduced. Further, compared with the conventional operation involving labor force, the operation of the present disclosure is smarter, thus reducing the fault rate of the manual operations.

In a specific embodiment, the method may be applied to a cloud of a centralized system of a game place, where a plurality of remote devices are a plurality of game tables in the game place. The operational maintenance personnel of the game place may manually define an operational maintenance task in the task list in advance. The operational maintenance task includes a task content, a plurality of remote device identifiers, and a task execution time, where each remote device identifier corresponds to one game table.

When the current time meets the task execution time of the operational maintenance task in the task list, an operational maintenance instruction corresponding to the task content is issued to a plurality of game tables respectively corresponding to a plurality of remote device identifiers in the operational maintenance task. Specifically, one thread for issuing the operational maintenance instruction of each game table may be established such that the operational maintenance instruction corresponding to the task content in the operational maintenance task is issued to a plurality of game tables in parallel through a plurality of threads. After receiving the operational maintenance instruction, the game table completes a corresponding operational maintenance operation such as software installation, upgrading, shutdown, running state switching and restart and the like, and returns a corresponding execution result to the cloud.

The cloud receives the execution result of the operational maintenance instruction returned by each game table and updates the state of the operational maintenance task based on the execution result. Further, in a case that the execution result is failed, a failed reason is marked for being viewed by operational maintenance personnel.

In this example, the cloud in the game place may issue an operational maintenance instruction corresponding to an operational maintenance task to a plurality of game tables at the same time, such that the plurality of game tables may perform a corresponding operational maintenance operation after receiving the operational maintenance instruction, and return an execution result. In this way, the operational maintenance personnel do not need to perform manual operation to the game tables in sequence in the game place, and a plurality of game tables can perform automatic maintenance and achieve consistent state with an extremely tiny time difference, which reduces the repetitive human labor. In particular, in a large scale game place, an operational maintenance instruction can be issued to a large number of game tables quickly such that the game tables can be synchronized in state quickly. An operational maintenance task may be set in advance on the cloud, and the game table can automatically perform the operations such as upgrading, state switching, and restarting during idle time, without human labor involved, which greatly reduces the labor costs and the time consumption. Further compared with the conventional operation involving labor force, the operation of the present disclosure is smarter, thus reducing the fault rate of the manual operations.

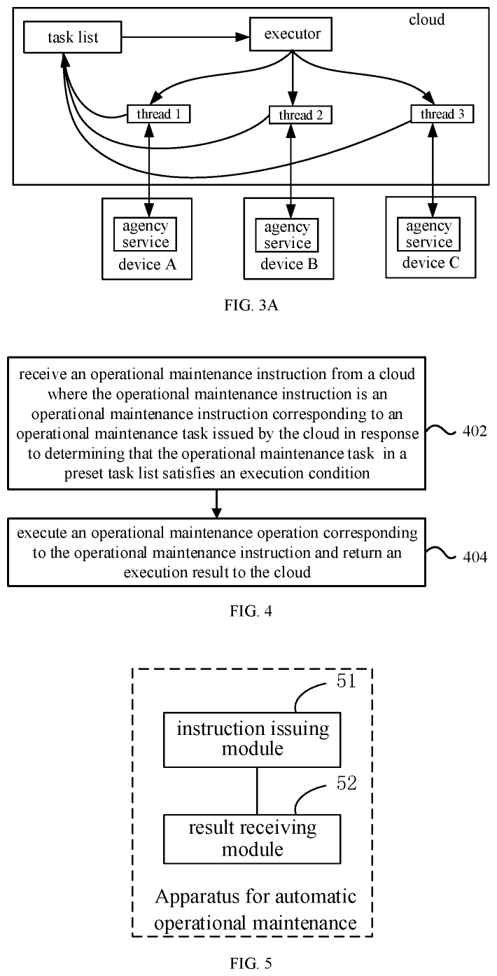

FIG. 4 is a flowchart of a method of automatic operational maintenance according to an embodiment of the present disclosure. The method may be applied in a remote device and include the following steps.

At step 402, an operational maintenance instruction is received from a cloud. The operational maintenance instruction is an operational maintenance instruction corresponding to an operational maintenance task issued by the cloud in response to determining that the operational maintenance task in a preset task list satisfies an execution condition.

In this embodiment, the remote device to be subjected to operational maintenance is not limited and may be a terminal device in an Internet of Things or large-scale equipment in an industrial system or the like.

The operational maintenance personnel may set the operational maintenance tasks in the task list and corresponding execution conditions in advance. In response to determining that an operational maintenance task in a preset task list satisfies an execution condition, an operational maintenance instruction corresponding to the operational maintenance task is issued to the remote device.

The remote device may receive the operational maintenance instruction from the cloud in various manners. For example, the operational maintenance instruction is received through a specified transmission channel; or, an agency service may be installed on the remote device in advance, and the agency service includes an interface for the cloud to perform remote call, for example, TCP interface of RPC, and thus the cloud may issue the operational maintenance instruction through the interface. Alternatively, the operational maintenance instruction may also be received by another remote tool, which is not limited herein.

At step 404, an operational maintenance operation corresponding to the operational maintenance instruction is executed with an execution result returned to the cloud.

The operational maintenance instruction may include at least one of remote device upgrading, application installation, running state switching, restart and shutdown. The remote device performs a corresponding operational maintenance operation after receiving the operational maintenance instruction. For example, in a case that the operational maintenance instruction is the running state switching, the remote device switches its own state and then returns a corresponding execution result to the cloud, where a specific running state switching instruction may be to instruct the remote device to switch to lower power, or to standby state. In a case that the operational maintenance instruction is application installation and shutdown, the remote device will obtain a corresponding application installation package. The application installation package may be an installation package stored locally by the remote device, or an installation package downloaded automatically from a server after the operational maintenance instruction is received. After completing application installation, the remote device prepares to shut down and return a corresponding execution result to the cloud.

After the execution operation is completed, the corresponding execution result is returned to the cloud. Specifically, the remote device may return the execution result by sending a packet to the cloud, or return the execution result through a specific transmission channel, or return the execution result through the above remotely-called interface. The execution result may include whether the operational maintenance instruction is completed successfully, an actual execution time, an actual execution duration and a failed reason for an unsuccessful execution and the like.

In the method of automatic operational maintenance provided in the embodiments of the present disclosure, an operational maintenance instruction corresponding to an operational maintenance task is issued through a cloud, such that a remote device may perform a corresponding operational maintenance operation after receiving the operational maintenance instruction, and return an execution result. In this way, the operational maintenance personnel can perform automatic maintenance to a device and know a maintenance result without performing manual operation to the device on a site. An execution condition for the operational maintenance task may be set in advance on the cloud and issued to the remote device when the operational maintenance task satisfies an execution condition, such that operational maintenance personnel can perform maintenance operations without having to wait until the maintenance precondition is satisfied. Therefore, labor costs and time consumption are greatly reduced. Further, compared with the conventional operation involving labor force, the operation of the present disclosure is smarter, thus reducing the fault rate of the manual operations.

An embodiment of the present disclosure provides an apparatus for automatic operational maintenance. The apparatus may be deployed on a cloud. As shown in FIG. 5, the apparatus may include an instruction issuing module 51, and a result receiving module 52.

The instruction issuing module 51 is configured to, in response to determining that an operational maintenance task in a preset task satisfies an execution condition, issue an operational maintenance instruction corresponding to the operational maintenance task to a remote device.

The result receiving module 52 is configured to receive an execution result corresponding to the operational maintenance instruction returned by the remote device.

In the apparatus for automatic operational maintenance provided in the embodiments of the present disclosure, an operational maintenance instruction corresponding to an operational maintenance task is issued through a cloud, such that a remote device may perform a corresponding operational maintenance task after receiving the operational maintenance instruction, and return an execution result. In this way, the operational maintenance personnel can perform automatic maintenance to a device and know a maintenance result without performing manual operation to the device on a site. An operational maintenance task may be set in advance on the cloud. When the operational maintenance task satisfies its task execution time condition, an operational maintenance instruction is issued to the remote device, such that the operational maintenance personnel can perform maintenance operations without having to wait until the maintenance precondition is satisfied. Therefore, labor costs and time consumption are greatly reduced. Further, compared with the conventional operation involving labor force, the operation of the present disclosure is smarter, thus reducing the fault rate of the manual operations.

In an example, the operational maintenance task includes a task content, a remote device identifier, and a task execution time; the instruction issuing module 51 is specifically configured to: when a current time meets a task execution time of the operational maintenance task in the preset task list, issue the operational maintenance instruction corresponding to the task content in the operational maintenance task to the remote device corresponding to the remote device identifier in the operational maintenance task.

In an example, the operational maintenance task includes a plurality of remote device identifiers; the instruction issuing module 51 is configured to issue the operational maintenance instruction corresponding to the task content in the operational maintenance task to the remote device corresponding to the remote device identifier in the operational maintenance task, including: issuing the operational maintenance instruction corresponding to the task content in the operational maintenance task to a plurality of remote devices corresponding to a plurality of remote device identifiers in the operational maintenance task respectively.

In an example, the instruction issuing module 51 is configured to issue the operational maintenance instruction corresponding to the task content in the operational maintenance task to the remote devices respectively corresponding to a plurality of remote device identifiers in the operational maintenance task, including: for each of the remote devices respectively corresponding to the plurality of remote device identifiers in the operational maintenance task, establishing a thread for the remote device; and issuing the operational maintenance instruction corresponding to the task content in the operational maintenance task to the plurality of remote devices in parallel through a plurality of the threads.

In an example, the operational maintenance instruction includes at least one of: remote device upgrading, application installation, running state switching, restart and shutdown.

In an example, after receiving the execution result of the operational maintenance instruction returned by the remote device, the result receiving module 52 is further configured to: update a state of the operational maintenance task based on the execution result.

In an example, after updating the state of the operational maintenance task based on the execution result, the result receiving module 52 is further configured to: in response to that the state of the operational maintenance task is failed, mark a failed reason in the execution result for the operational maintenance task, wherein the failed reason is used for being viewed by operational maintenance personnel.

In an example, after updating the state of the operational maintenance task based on the execution result, the result receiving module 52 is further configured to: generate promotion information based on the updated state of the operational maintenance task, wherein the promotion information is used to notify the operational maintenance personnel of the execution result for the operational maintenance task.

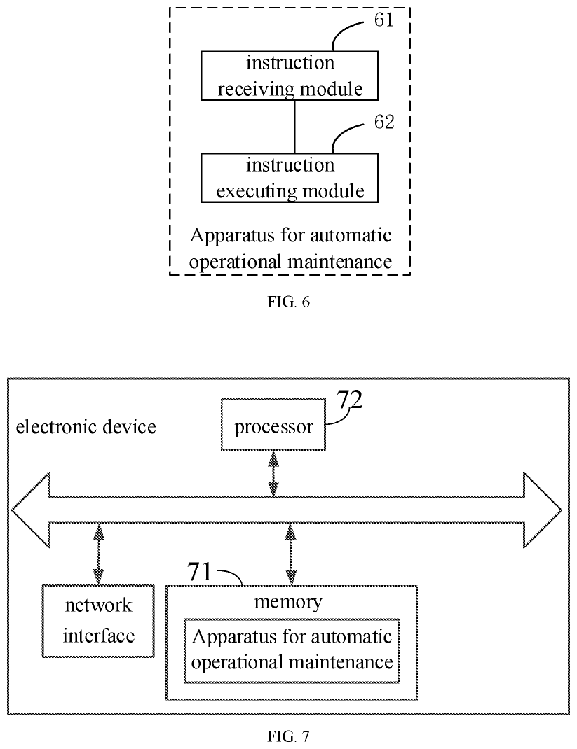

An embodiment of the present disclosure provides another apparatus for automatic operational maintenance, which may be deployed on a remote device. As shown in FIG. 6, the apparatus includes an instruction receiving module 61 and an instruction executing module 62.

The instruction receiving module 61 is configured to receive an operational maintenance instruction from a cloud, wherein the operational maintenance instruction is an operational maintenance instruction corresponding to an operational maintenance task issued by the cloud in response to that determining the operational maintenance task in a preset task list satisfies an execution condition.

The instruction executing module 62 is configured to execute an operational maintenance operation corresponding to the operational maintenance instruction and return an execution result to the cloud.

The implementation processes of the functions and effects of the above various modules in the above apparatus may be referred to the implementation process of corresponding steps of the above method and thus will not be repeated herein.

An embodiment of the present disclosure further provides an electronic device. As shown in FIG. 7, the electronic device includes a memory 71, a processor 72, wherein the memory 71 is configured to store computer instructions run on the processor 72, and the processor 72 is configured to, when executing the computer instructions, implement the method of automatic operational maintenance according to any one embodiment of the present disclosure.

An embodiment of the present disclosure further provides a computer program product, including computer programs/instructions, wherein the computer programs/instructions are executed by a processor to implement the method of automatic operational maintenance according to any one embodiment of the present disclosure.

An embodiment of the present disclosure further provides a computer readable storage medium, storing computer programs, wherein the computer programs are executed by a processor to implement the method of automatic operational maintenance according to any one embodiment of the present disclosure.

Since the apparatus embodiments substantially correspond to the method embodiments, a reference may be made to part of the descriptions of the method embodiments for the related part. The apparatus embodiments described above are merely illustrative, where the units described as separate members may be or not be physically separated, and the members displayed as units may be or not be physical units, i.e., may be located in one place, or may be issued to a plurality of network units. Part or all of the modules may be selected according to actual requirements to implement the objectives of the solutions in the embodiments. Those of ordinary skill in the art may understand and carry out them without creative work.

The specific embodiments are described as above. Other embodiments may also be obtained within the scope of the appended claims. In some cases, the actions or steps recorded in the claims may be performed in a sequence different from the embodiments to achieve the desired result. Further, the processes shown in drawings do not necessarily require a particular sequence or a continuous sequence to achieve the desired result. In some embodiments, a multi-task processing and parallel processing are possible and may also be advantageous.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the related art that are not disclosed in the present disclosure. The specification and embodiments are considered as exemplary only, with a true scope and spirit of the present disclosure being indicated by the following claims.

It is to be understood that the present disclosure is not limited to the precise structure described above and shown in the accompanying drawings, and that various modifications and changes may be made without departing from the scope thereof. The scope of the present disclosure is limited only by the appended claims.

The foregoing disclosure is merely illustrative of preferred embodiments of the present disclosure but not intended to limit the present disclosure, and any modifications, equivalent substitutions, adaptations thereof made within the spirit and principles of the disclosure shall be encompassed in the scope of protection of the present disclosure.

1. A method of automatic operational maintenance, being applicable to a cloud, and comprising:
in response to determining that an operational maintenance task in a preset task list satisfies an execution condition, issuing an operational maintenance instruction corresponding to the operational maintenance task to a remote device;
receiving an execution result in response to the operational maintenance instruction returned by the remote device.

2. The method according to claim 1, wherein,
the operational maintenance task comprises a task content, a remote device identifier, and a task execution time;
determining that an operational maintenance task in the preset task list satisfies an execution condition comprises:
determining that a current time meets the task execution time of an operational maintenance task in the preset task list;
issuing an operational maintenance instruction corresponding to the operational maintenance task to a remote device comprises:
issuing the operational maintenance instruction corresponding to the task content in the operational maintenance task to a remote device corresponding to the remote device identifier in the operational maintenance task.

3. The method according to claim 2, wherein the operational maintenance task comprises a plurality of remote device identifiers; issuing an operational maintenance instruction corresponding to the task content in the operational maintenance task to a remote device corresponding to the remote device identifier in the operational maintenance task comprises:
issuing the operational maintenance instruction corresponding to the task content in the operational maintenance task to a plurality of remote devices respectively corresponding to the plurality of remote device identifiers in the operational maintenance task.

4. The method according to claim 3, wherein issuing the operational maintenance instruction corresponding to the task content in the operational maintenance task to the remote devices respectively corresponding to the plurality of remote device identifiers in the operational maintenance task comprises:
for each of the remote devices respectively corresponding to the plurality of remote device identifiers in the operational maintenance task, establishing a thread for the remote device; and
issuing the operational maintenance instruction corresponding to the task content in the operational maintenance task to the plurality of remote devices in parallel through a plurality of the threads.

5. The method according to claim 1, wherein, the operational maintenance instruction comprises at least one of: remote device upgrading, application installation, running state switching, restart and shutdown.

6. The method according to claim 1, further comprises:
updating a state of the operational maintenance task based on the execution result.

7. The method according to claim 6, further comprises:
in response to that the state of the operational maintenance task is failed, marking the operational maintenance task with a failed reason in the execution result, wherein the failed reason is to be viewed by an operational maintenance personnel.

8. The method according to claim 6, further comprises:
generating promotion information based on the updated state of the operational maintenance task, wherein the promotion information is to notify an operational maintenance personnel of the execution result for the operational maintenance task.

9. A method for automatic operational maintenance, being applicable to a remote device, and comprising:
receiving an operational maintenance instruction from a cloud, wherein the operational maintenance instruction corresponds to an operational maintenance task in a preset task and is issued by the cloud in response to determining that the operational maintenance task satisfies an execution condition;
executing an operational maintenance operation corresponding to the operational maintenance instruction; and
returning an execution result to the cloud.

10. An electronic device, comprising a memory and a processor, wherein the memory is configured to store computer instructions run on the processor, and the processor is configured to, when executing the computer instructions, implement the method of automatic operational maintenance, the method comprising:
in response to determining that an operational maintenance task in a preset task list satisfies an execution condition, issuing an operational maintenance instruction corresponding to the operational maintenance task to a remote device;
receiving an execution result in response to the operational maintenance instruction returned by the remote device.

11. The electronic device according to claim 10, wherein,
the operational maintenance task comprises a task content, a remote device identifier, and a task execution time;
determining that an operational maintenance task in the preset task list satisfies an execution condition comprises:
determining that a current time meets the task execution time of an operational maintenance task in the preset task list;
issuing an operational maintenance instruction corresponding to the operational maintenance task to a remote device comprises:
issuing the operational maintenance instruction corresponding to the task content in the operational maintenance task to a remote device corresponding to the remote device identifier in the operational maintenance task.

12. The electronic device according to claim 11, wherein the operational maintenance task comprises a plurality of remote device identifiers; issuing an operational maintenance instruction corresponding to the task content in the operational maintenance task to a remote device corresponding to the remote device identifier in the operational maintenance task comprises:
issuing the operational maintenance instruction corresponding to the task content in the operational maintenance task to a plurality of remote devices respectively corresponding to the plurality of remote device identifiers in the operational maintenance task.

13. The electronic device according to claim 12, wherein issuing the operational maintenance instruction corresponding to the task content in the operational maintenance task to the remote devices respectively corresponding to the plurality of remote device identifiers in the operational maintenance task comprises:
for each of the remote devices respectively corresponding to the plurality of remote device identifiers in the operational maintenance task, establishing a thread for the remote device; and
issuing the operational maintenance instruction corresponding to the task content in the operational maintenance task to the plurality of remote devices in parallel through a plurality of the threads.

14. The electronic device according to claim 10, wherein, the operational maintenance instruction comprises at least one of: remote device upgrading, application installation, running state switching, restart and shutdown.

15. The electronic device according to claim 10, further comprises:
updating a state of the operational maintenance task based on the execution result.

16. The electronic device according to claim 15, further comprises:
in response to that the state of the operational maintenance task is failed, marking the operational maintenance task with a failed reason in the execution result, wherein the failed reason is to be viewed by an operational maintenance personnel.

17. The electronic device according to claim 15, further comprises:
generating promotion information based on the updated state of the operational maintenance task, wherein the promotion information is to notify an operational maintenance personnel of the execution result for the operational maintenance task.
